(19) United States
(12) Patent Application Publication
(10) Pub. No.: US 2017/0330547 A1
(43) Pub. Date: Nov. 16, 2017

(54) METHODS AND SYSTEMS FOR REDUCING A PRESSURE WAVE

(71) Applicant: GM GLOBAL TECHNOLOGY OPERATIONS LLC, Detroit, MI (US)

(72) Inventors: MARK A. STEBBINS, BLOOMFIELD HILLS, MI (US); GEOFREY S. COX, MILFORD, MI (US); JOSEPH A. SCHUDT, MACOMB, MI (US)

(73) Assignee: GM GLOBAL TECHNOLOGY OPERATIONS LLC, Detroit, MI (US)

(21) Appl. No.: 15/150,620

(22) Filed: May 10, 2016

(51) Int. Cl. G10K 11/175; F25D 17/06

(52) U.S. Cl. CPC G10K 11/175; F25D 17/06; G10K 2210/507; G10K 2210/1282

(57) ABSTRACT

Methods and systems for reducing a pressure wave are provided. In an exemplary embodiment, a motor vehicle comprises a cabin and a receiver positioned to detect an input pressure wave within the cabin and produce an input signal. A fan with a blade having a variable pitch is positioned within the vehicle where the fan is audible within the cabin. A processor is in communication with the receiver and the fan, where the processor is configured to receive the input signal and determine an input frequency and an input phase. The processor is further configured to instruct the fan to control a pitch of the blade to produce a cancellation pressure wave with a cancellation frequency that is about the same as the input frequency and a cancellation phase that is about 180° out of phase with the input phase.

### TECHNICAL FIELD

The technical field generally relates to active noise cancellation systems, and more particularly relates to active noise cancellation systems for motor vehicles.

### BACKGROUND

The cabin environment is an important aspect for the user of a motor vehicle. Many people spend extended periods of time in a motor vehicle, so comfort is a key consideration. However, there are inherent aspects associated with a motor vehicle that are not comfortable. For example, a motor vehicle has a motor and moves over the terrain of a road. Noise and vibrations are typical in most motor vehicles, and these can prove displeasing over extended periods of time. The motor for many vehicles generates noise and vibration, and the tires rolling over the road can also generate noise and vibration. Other factors can also produce noise or vibration within a vehicle. In some cases, vibrations are produced below the normal human hearing range of humans, which is commonly referred to sub-audible sound for humans. An example of such a phenomenon is the cabin boom effect oftentimes produced when driving with a single window down. This example presents an open cavity specific forced example but can be extended to a closed cavity and other forced response cases. Systems and methods that reduce or cancel noise can be expensive and/or heavy, and price and weight are important aspects of a motor vehicle.

Accordingly, it is desirable to provide systems and methods to reduce noise or other pressure waves in a motor vehicle. In addition, it is desirable to provide systems and methods of noise reduction that utilize existing components in a motor vehicle. Furthermore, other desirable features and characteristics of the present embodiment will become apparent from the subsequent detailed description and the appended claims, taken in conjunction with the accompanying drawings and this background of the invention.

### BRIEF SUMMARY

Methods and systems for reducing a pressure wave are provided. In an exemplary embodiment, a motor vehicle comprises a cabin and a receiver positioned to detect an input pressure wave within the cabin. The receiver is configured to produce an input signal. A fan with a blade having a variable pitch is positioned within the vehicle where the fan is audible within the cabin. A processor is in communication with the receiver and the fan, where the processor is configured to receive the input signal and determine an input frequency and an input phase. The processor is further configured to instruct the fan to control a pitch of the blade to produce a cancellation pressure wave with a cancellation frequency that is about the same as the input frequency and a cancellation phase that is about 180° out of phase with the input phase.

A method for reducing a pressure wave is provided in another embodiment. The method includes measuring an input pressure wave with a receiver, and determining an input frequency and an input phase of the input pressure wave. A fan operation is adjusted to produce a cancellation pressure wave with a cancellation frequency that is about the same as the input frequency and a cancellation phase that is about 180° out of phase with the input phase. Adjusting the fan operation includes adjusting one or more of a fan speed and a pitch of a blade of a fan.

A system of reducing a pressure wave is provided in yet another embodiment. The system includes a receiver positioned to monitor and measure an input pressure wave and to produce an input signal. A fan in positioned within audible range of the input pressure wave, where the fan has a blade with a variable pitch. A processor is in communication with the receiver and the fan, and the processor is configured to receive the input signal and determine an input frequency and an input phase of the input signal. The processor is further configured to instruct the fan to vary a pitch of the blade to produce a cancellation pressure wave having a cancellation frequency that is about the same as the input frequency and a cancellation phase that is about 180° out of phase with the input phase.

### BRIEF DESCRIPTION OF THE DRAWINGS

The present embodiments will hereinafter be described in conjunction with the following drawing figures, wherein like numerals denote like elements, and wherein:

FIG. 1 is a representation of an exemplary motor vehicle;

FIG. 2 is a schematic drawing of an active noise control system;

FIG. 3 is an exemplary fan having blades with a variable pitch;

FIG. 4 illustrates an exemplary embodiment of an input pressure wave, in the time domain, and a corresponding cancellation pressure wave;

FIG. 5 illustrates an alternate embodiment of an input pressure wave, in the frequency domain, and a corresponding cancellation pressure wave;

FIG. 6 illustrates an exemplary embodiment of a heating, ventilation, and air conditioning system in a motor vehicle;

FIG. 7 illustrates an exemplary embodiment of a fan mounted on a back shelf of a cabin in a motor vehicle; and

FIG. 8 illustrates an exemplary embodiment of a fan mounted behind a speaker.

### DETAILED DESCRIPTION

The following detailed description is merely exemplary in nature and is not intended to limit the various embodiments or the application and uses thereof. Furthermore, there is no intention to be bound by any theory presented in the preceding background or the following detailed description.

Active noise cancellation is a newly emerging technology employed on many modern vehicles. While the specific techniques may vary, the underlying goal remains the same: to monitor an existing noise field within a vehicle cabin and mitigate/suppress it. Rather than using traditional speakers and amplifiers to provide a cancellation noise, this method employs an active fan equipped with variable pitch blades to produce a sound equal in magnitude and opposite in phase to the nuisance sound. This effectively “cancels” the nuisance sound. This is the same theory governing existing active noise cancellation systems. Specifically, this variable pitch rotor technique addresses both sub audible (below ˜20 Hz) and Audible (above ˜20 Hz) “cavity boom”. A common example of this phenomenon is most commonly experienced while driving with only a single window open. Vortices shed from the body structure interfere with the vehicle cavity air mass and pressure, producing the sound. This example presents an open cavity specific forced example but can be extended to a closed cavity and other forced response cases.

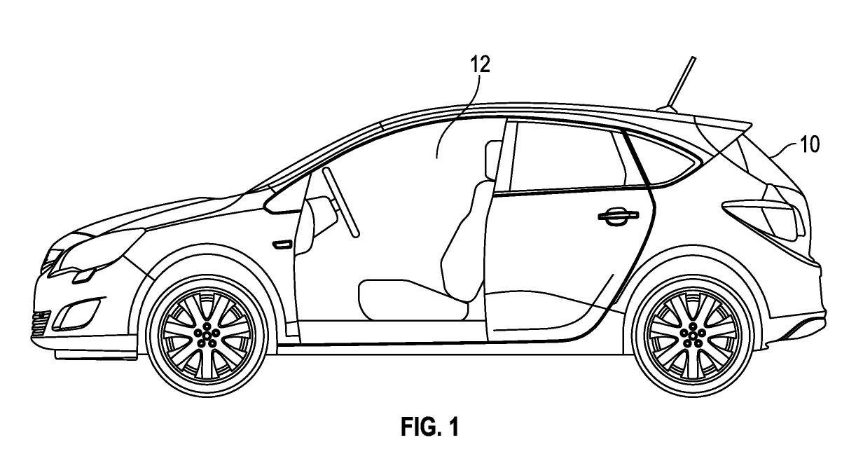

Reference is made to an exemplary embodiment illustrated in FIG. 1. A motor vehicle 10 includes a cabin 12. Doors may provide cabin 12 access, and the cabin 12 may also include seats, windows, a steering wheel, and other vehicle components. The current embodiment is described in the context of a cabin 12 within a motor vehicle 10, but other embodiments are also possible, such as a room, a studio, an aircraft, or a wide variety of other enclosures or open spaces. The cabin 12 is generally an enclosed space, but other temporary openings may exist, such as windows or doors that open and close. There may also be permanent openings, such as a vent or hole.

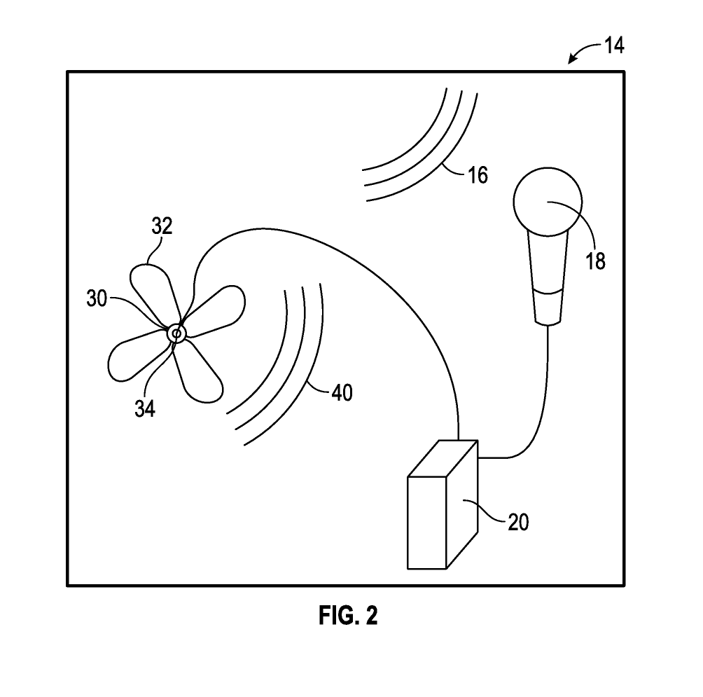

An active noise control system 14 is configured to limit or reduce pressure waves within the cabin 12, as illustrated in an exemplary embodiment in FIG. 2 with continuing reference to FIG. 1. Audible sound is one type of pressure wave, but a pressure wave may possess frequency content beyond the limits of human hearing. In an exemplary embodiment, an input pressure wave 16 in an unwanted pressure wave, such as engine, tire, or other induced road noises. The input pressure wave 16 is detected by a receiver 18 such as a microphone, but other receivers 18 may be used in alternate embodiments. For example, a strain gauge or other devices capable of detecting a pressure wave may be used. The receiver 18 produces an input signal, where the input signal is electrical in an exemplary embodiment. The input signal may be other types of signals in other embodiments, such as a light signal for fiber optic systems. The receiver 18 is positioned to detect a pressure wave within the cabin 12 in an exemplary embodiment, but the receiver 18 may be positioned in other locations to monitor and measure the input pressure wave 16 in embodiments other than a motor vehicle 10. The receiver 18 may be an existing microphone in some embodiments. For example, some motor vehicles 10 include a microphone configured to receive verbal commands from an occupant of the cabin 12, and the same microphone may be used to detect the input pressure wave 16. In alternate embodiments, other microphones or other receivers 18 may be used. The receiver 18 may be positioned almost anywhere that allows the receiver 18 to detect pressure waves within the cabin 12.

The motor vehicle 10 includes a processor 20 that may include a wide variety of hardware and software configurations. The processor 20 can include any type of processor hardware or multiple processors, integrated circuits such as microprocessors, or any suitable number of integrated circuit devices and/or circuitry working in cooperation to accomplish the tasks of the processor 20. The processor 20 executes one or more programs that may be stored within memory. The processor 20 may include, or have access to, any type of memory, including but not limited to random access memory (RAM), read only memory (ROM), erasable programmable read only memory (EPROM), electrically erasable programmable read only memory (EEPROM), and non-volatile random access memory (NVRAM). The memory can store any information needed for the operation of the processor 20, as described herein. The processor 20 may be part of other systems on the motor vehicle 10, or it may be a dedicated device.

The processor 20 is in communication with the receiver 18. A wide variety of communication systems may be employed in various embodiments. For example, a wire may be used for electrical communication, fiber optics may be used for light communication, and various wireless techniques may also be utilized. The processor 20 is configured to receive the input signal and determine its frequency content and an input phase of the input signal, where the input signal is representative of the input pressure wave 16. The input pressure wave 16 has an input frequency and an input phase, where the input frequency is the number of occurrences of a repeating event over time, such as the number of pressure peaks over time. The input phase is a relationship in time between successive states of an oscillating system as compared to a reference point. The phase may represent when the peaks or valleys of a pressure wave occur, and the phase can be relative to another wave or relative to a fixed time. The input pressure wave 16 also has an input amplitude, where the input amplitude is the distance between a neutral pressure and a peak pressure. The neutral pressure is typically about half way between a maximum and a minimum pressure of the input pressure wave 16. The processor may also be configured to determine the input amplitude.

The processor 20 may further be configured to compare the input signal to an expected signal, where the expected signal is a pre-determined signal based on operating conditions. For example, the expected signal may be based on the engine's revolutions per minute (RPM), where the sound or pressure wave produced by the engine at set RPMs is known. Alternatively, the expected signal may be based on vehicle speed, where the expected signal corresponds to an expected noise the tires produce at a given speed. Many other factors may influence the expected signal, and the expected signal may change. For example, at low speeds the expected signal may depend on the engine RPM, and at higher speeds the expected signal may depend on the noise produced by the tires on the road. Many other factors may influence the expected signal as well, such as noise from the transmission or other sources, sound from a radio or other entertainment system, or a combination of various factors. The input signal may be compared to the expected signal by the processor 20, where aspects of the input signal matching the expected signal are referred to as coherent pressure waves, and aspects of the input signal differing from the expected signal are referred to as incoherent pressure waves. The coherent pressure waves may represent the undesired sound, such as engine noise, and the incoherent pressure waves typically represent desired sounds, such as speech or music. The processor 20 may optionally be configured to cancel the coherent pressure waves, and not to cancel the incoherent pressure waves, as described more fully below.

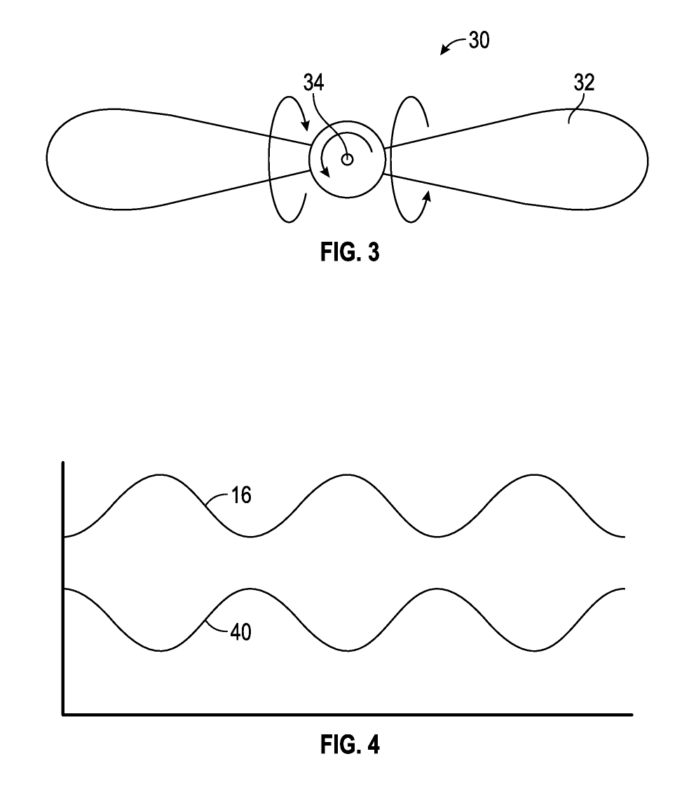

The motor vehicle 10 also includes a fan 30 with one or more blades 32, where the fan 30 includes multiple blades 32 in many embodiments. The fan 30 is positioned such that the fan 30 is audible within the cabin 12, or within audible range of the input pressure wave 16 for embodiments other than a motor vehicle 10. The fan 30 may urge air into the cabin 12 in some embodiments, but it is also possible for the fan 30 to be audible within the cabin 12 without urging air into the cabin 12. The blade 32 of the fan 30 has a variable pitch, as illustrated in FIG. 3, and the variable pitch may be controlled.

In an exemplary embodiment, all the blades 32 of the fan 30 have a variable pitch, where the pitch of all the blades 32 are controlled in unison such that each blade 32 has the same pitch as every other blade 32. As such, the fan 30 is capable of changing the pitch of each and every one of the plurality of blades 32 simultaneously and to the same degree. However, in other embodiments, one or more of the blades 32 may be controlled differently than one or more other blades 32 such that the fan 30 includes blades 32 with different pitches at a given moment in time. The fan 30 may be one or more of several different types of fans, including a squirrel cage, a propeller fan, and other types of fans, but the fan 30 does include a variable pitch blade 32 in all embodiments. The fan 30 produces an audible noise or pressure wave, and the frequency and phase depends on the speed of the fan 30 and the pitch of the blades 32.

Referring again to FIGS. 1 and 2, with continuing reference to FIGS. 3 and 4, the processor 20 is in communication with the fan 30. The processor 20 may be in communication with the fan 30 in a variety of manners, such as electrical communication with a wire, optical communication with fiber optics, or wireless communication. The processor 20 is configured to instruct the fan 30 to vary the pitch of the blade 32 to produce a cancellation pressure wave 40. In an exemplary embodiment, the processor 20 uses a control algorithm to send a command signal to a blade actuator (not illustrated) of the fan 30, where the actuator positions the blades 32 to a precisely controlled blade pitch. The processor 20 calculates the proper blade position and fan speed to produce an output frequency for the cancellation pressure wave 40 that is about equal to the input or target frequency of the input pressure wave 16 but opposite in phase. The processor 20 may also optionally instruct the fan 30 to control the fan speed to further control the cancellation pressure wave 40. Existing deterministic models predicting fan pressure waves are used to match the cancellation pressure wave 40 with the input pressure wave 16, where the deterministic models have shown good agreement with experimentation. This active noise cancellation technique capitalizes upon the deterministic relationship governing a spinning rotor's geometry and its associated sound pressure field. The receiver 18 measures the existing sounds within the cabin 12. This time domain information is then mapped to a frequency domain wherein specific frequency content is identified through the input signal's frequency spectrum (amplitude and phase). A low frequency signal content exhibiting the greatest amplitude, or power, may be chosen for attenuation. This selected low frequency portion of the input signal may become a target frequency in some embodiments.

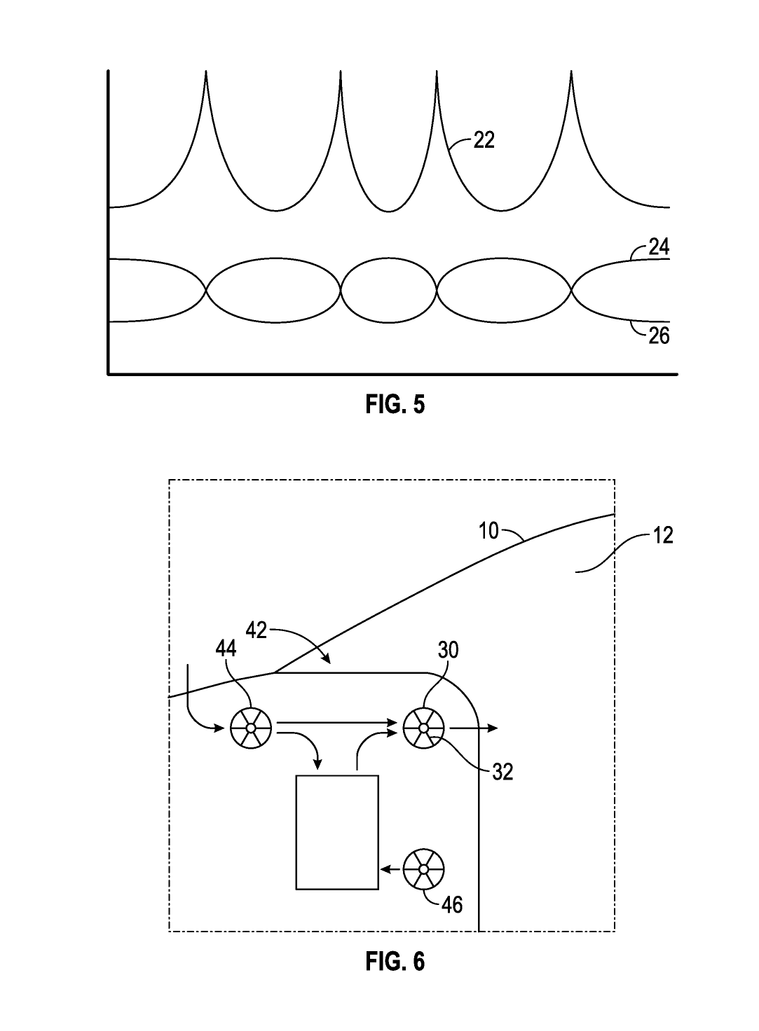

Referring to FIG. 5, with continuing reference to FIGS. 1-4, a frequency spectrum magnitude 22 may be about the same for the input pressure wave 16 and the for the cancellation pressure wave 40, where FIG. 5 illustrates the frequency spectrum magnitude 22 for the input pressure wave 16 and the cancellation pressure wave 40 as a single line. An input frequency spectrum phase 24 of the input pressure wave 16 and a cancellation frequency spectrum phase 26 of the cancellation pressure wave 40 are about inverted, as illustrated, so a negligible total pressure wave results. Theoritically, perfect matching of the frequency spectrum magnitude 22 for the input pressure wave 16 and the cancellation pressure wave 40, combined with perfect inversion of the input frequency spectrum phase 24 and the cancellation frequency spectrum phase 26 results in perfect cancellation of the input pressure wave 16 such that no sound or pressure wave results.

Referring again to FIG. 4, with continuing reference to FIGS. 1-3, the cancellation pressure wave 40 exhibits a cancellation frequency that is about the same as the input frequency, and the cancellation pressure wave 40 has a cancellation phase that is about 180 degrees (°) out of phase with the input phase. As such, the cancellation pressure wave 40 has peaks that correspond with troughs of the input pressure wave 16, and the cancellation pressure wave 40 has troughs that correspond with the peaks of the input pressure wave 16. The processor 20 calculates one or more of the pitch of the blades 32 and the fan speed to control the cancellation pressure wave 40 such that the cancellation pressure wave 40 at least partially cancels the input pressure wave 16. The processor 20 may optionally control the operations of the fan 30, as described above, to control a cancellation amplitude of the cancellation pressure wave 40, but even if the cancellation amplitude does not match the input amplitude the cancellation pressure wave 40 will at least reduce the input pressure wave effects. When the cancellation amplitude is less than the input amplitude, the cancellation pressure wave 40 will partially cancel the input pressure wave 16, so the effects of the input pressure wave 16 are reduced.

In some embodiments, the fan 30 and processor 20 are configured to produce a cancellation pressure wave 40 with a cancellation frequency of from about 10 to about 100 hertz. This relatively low frequency range matches much of the unwanted noise or pressure waves from a motor vehicle 10. This also fits within the frequency range of pressure waves most fans 30 produce. The fan 30 serves to produce the cancellation pressure wave 40, as described above, and in some embodiments one or more fans 30 are the only device(s) producing the cancellation pressure wave 40. Thus, the cancellation frequency is limited to what can be achieved by controlling the fan's operation, as described above. The active noise control system 14 with a fan 30 allows for good control of lower frequency pressure waves, as described above. These lower frequency pressure waves are generally consistent throughout the cabin so fan placement and the input pressure wave generation point are not critical. Higher frequencies tend to be more localized within a cabin 12, so effective active noise cancellation systems targeting the higher frequencies may benefit from targeting specific locations within the cabin 12.

In some embodiments, the input pressure wave 16 may not have a constant input frequency, and/or the input pressure wave 16 may not have a single spectral peak. In such cases, the fan 30 may be controlled to produce a variable cancellation pressure frequency that matches the inconsistent and varied input frequency of the input pressure wave 16. FIG. 5 illustrates the frequency spectrum magnitude 22 and input frequency spectrum phase 24 for an input pressure wave 16 that is not constant, as seen by the variable spacing. The fan 30 also produces a variable cancellation phase remaining about 180° out of phase with the variable input phase. This may involve rapid changes in the pitch of the blade 32. The processor 20 may instruct the fan 30 to vary operations and produce the cancellation pressure wave 40 to match the coherent pressure waves while ignoring the incoherent pressure waves. As such, the processor 20 may be able to accurately anticipate irregular frequencies and/or irregular input pressure wave shapes because the processor 20 may only instruct the fan 30 to produce a cancellation pressure wave 40 that matches the coherent pressure waves known from the expected signal. In an alternate embodiment, the processor 20 may instruct the fan 30 to produce the cancellation pressure wave 40 to match the incoherent pressure waves while ignoring the coherent pressure waves, such as in an embodiment where the expected signal is a desired sound like the radio. The cancellation pressure wave 40 may also be generated to control “cabin boom” created by driving with a single window open.

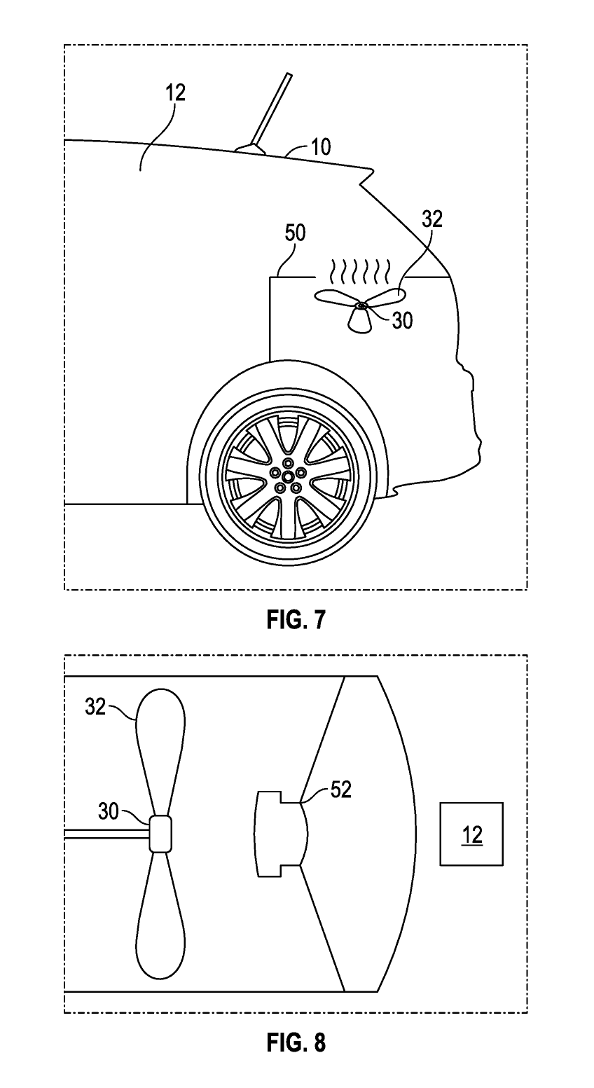

The fan 30 may be positioned in a wide variety of locations where the fan 30 is audible within the cabin 12, and some of those locations are within the cabin 12. For example, the fan 30 may be positioned within a heating, ventilation, and air conditioning (HVAC) unit 42, as illustrated in FIG. 6 with continuing reference to FIGS. 1 and 2. In the illustrated embodiment, the fan 30 in the HVAC unit 42 urges air into the cabin 12. The HVAC unit 42 may optionally include a fresh air blower 44, an air conditioner blower 46, a heater blower (not illustrated), or other blowers. The fan 30 may be in addition to the blowers provided for operation of the HVAC unit 42, as illustrated, or the fan 30 may replace one or more of the blowers provided with the HVAC unit 42. Referring to an exemplary embodiment in FIG. 7, the fan 30 may be positioned on a back shelf 50 of the cabin 12, where the fan 30 is audible within the cabin 12. In yet another embodiment illustrated in FIG. 8, the fan 30 may be positioned behind a speaker 52 for the cabin 12, where the speaker 52 includes a cone that allows some air flow therethrough. The fan 30 may be positioned in other locations as well.

The active noise control system 14 described herein uses a fan 30 in place of a speaker to cancel unwanted pressure waves. A fan 30 is generally lighter than the typical active noise cancellation speakers. In addition, a fan 30 also weights less and is less massive than layers of sound adsorbing material used to suppress unwanted noise. The fan 30 may be quite effective at producing a cancellation pressure wave 40 at the lower frequencies described above, so the reduced weight with good pressure wave cancellation provides a benefit to the cabin occupants.

While at least one exemplary embodiment has been presented in the foregoing detailed description, it should be appreciated that a vast number of variations exist. It should also be appreciated that the exemplary embodiments are only examples, and are not intended to limit the scope, applicability, or configuration of the application in any way. Rather, the foregoing detailed description will provide those skilled in the art with a convenient plan for implementing one or more embodiments, it being understood that various changes may be made in the function and arrangement of elements described in an exemplary embodiment without departing from the scope, as set forth in the appended claims.

What is claimed is:

1. A motor vehicle comprising:
a cabin;
a receiver positioned to detect an input pressure wave within the cabin, where the receiver is configured to produce an input signal;
a fan positioned within the motor vehicle, wherein the fan is audible within the cabin, and wherein the fan comprises a blade having a pitch that is variable; and
a processor in communication with the receiver and the fan, wherein the processor is configured to receive the input signal and determine an input frequency and an input phase of the input signal, wherein the processor is configured to instruct the fan to control the pitch of the blade of the fan to produce a cancellation pressure wave, wherein the cancellation pressure wave has a cancellation frequency that is about the same as the input frequency, and wherein the cancellation pressure wave has a cancellation phase that is about 180° out of phase with the input phase.

2. The motor vehicle of claim 1 wherein the fan comprises a squirrel fan.

3. The motor vehicle of claim 1 wherein the fan comprises a plurality of blades, and all of the plurality of blades have the pitch that is variable.

4. The motor vehicle of claim 3 wherein the pitch of all of the plurality of blades changes simultaneously and to the same degree.

5. The motor vehicle of claim 1 wherein the processor is further configured to instruct the fan to change a fan speed.

6. The motor vehicle of claim 1 wherein the fan is positioned within a heating, ventilation, and air conditioning system of the motor vehicle.

7. The motor vehicle of claim 6 wherein the fan urges air from the heating, ventilation, and air conditioning system of the motor vehicle into the cabin.

8. The motor vehicle of claim 1 wherein the fan is positioned behind a speaker.

9. The motor vehicle of claim 1 wherein the fan is positioned on a back shelf of the cabin.

10. The motor vehicle of claim 1 wherein the processor is configured to instruct the fan to produce the cancellation pressure wave wherein the cancellation frequency varies.

11. The motor vehicle of claim 1 wherein the processor is configured to instruct the fan to produce the cancellation pressure wave wherein the cancellation frequency is from about 10 to about 100 hertz.

12. The motor vehicle of claim 1 wherein:
the processor is configured to compare the input signal to an expected signal, wherein aspects of the input signal matching the expected signal are a coherent pressure wave and aspects of the input signal that are different than the expected signal are an incoherent pressure wave; and
wherein the processor is configured to instruct the fan to produce the cancellation pressure wave wherein the cancellation frequency about matches the coherent pressure wave and the cancellation phase is about 180° out of phase with the coherent pressure wave.

13. The motor vehicle of claim 1 wherein:
the processor is configured to compare the input signal to an expected signal, wherein aspects of the input signal matching the expected signal are a coherent pressure wave and aspects of the input signal that are different than the expected signal are an incoherent pressure wave; and
wherein the processor is configured to instruct the fan to produce the cancellation pressure wave wherein the cancellation frequency about matches the incoherent pressure wave and the cancellation phase is about 180° out of phase with the incoherent pressure wave.

14. A method of reducing an input pressure wave, the method comprising the steps of:
measuring the input pressure wave with a receiver;
determining an input frequency and an input phase of the input pressure wave; and
adjusting a fan operation to produce a cancellation pressure wave, wherein the cancellation pressure wave has a cancellation frequency that is about the same as the input frequency, and wherein the cancellation pressure wave has a cancellation phase that is about 180° out of phase with the input phase, and wherein adjusting the fan operation comprising adjusting one or more of a fan speed and a pitch of a blade of a fan.

15. The method of claim 14 wherein measuring the input pressure wave comprises generating an input signal.

16. The method of claim 15 further comprising:
comparing the input signal to an expected signal wherein aspects of the input signal matching the expected signal are a coherent pressure wave and aspects of the input signal that differing from the expected signal are an incoherent pressure wave; and
wherein adjusting the fan operation comprises adjusting the fan operation to produce the cancellation pressure wave wherein the cancellation frequency about matches the coherent pressure wave and wherein the cancellation phase is about 180° out of phase with the coherent pressure wave.

17. A system for reducing an input pressure wave comprising:
a receiver positioned to monitor the input pressure wave, wherein the receiver is configured to measure the input pressure wave and produce an input signal;
a fan positioned within audible range of the input pressure wave, wherein the fan comprises a blade having a pitch that is variable; and
a processor in communication with the receiver and the fan, wherein the processor is configured to receive the input signal and determine an input frequency and an input phase of the input signal, wherein the processor configured to instruct the fan to vary a pitch of the blade to produce a cancellation pressure wave having a cancellation frequency and a cancellation phase, wherein the cancellation frequency is about the same as the input frequency and the cancellation phase is about 180° out of phase with the input phase.

18. The system of claim 17 wherein the processor is configured to instruct the fan to vary the pitch of the blade to produce the cancellation pressure wave wherein the cancellation frequency is from about 10 to about 100 hertz.

19. The system of claim 17 wherein the processor is configured to instruct the fan to vary a fan speed.

20. The system of claim 17 wherein the processor is configured to instruct the fan to vary the pitch of the blade and a fan speed to produce the cancellation pressure wave wherein the cancellation pressure wave has a cancellation amplitude about the same as an input amplitude.
